(19) United States
(12) Patent Application Publication
(10) Pub. No.: US 2011/0238618 A1
(43) Pub. Date: Sep. 29, 2011

(54) Medical Collaboration System and Method

(76) Inventors: Michael Valdiserri, Tucson, AZ (US); Warren Goble, Tucson, AZ (US)

(21) Appl. No.: 13/072,574

(22) Filed: Mar. 25, 2011

Related U.S. Application Data
(60) Provisional application No. 61/317,556, filed on Mar. 25, 2010.

(51) Int. Cl. G06F 17/30

(52) U.S. Cl. 707/608; 707/E17.008; 707/E17.019

(57) ABSTRACT

Some embodiments of the invention provide a method of medical collaboration. Some embodiments include a server application receiving and storing an image via an uploading application. In some embodiments, the image can be stored in a database, and upon receiving a request to view the image from a plurality of client applications, the image can be transmitted to the plurality of client applications so that each of the client applications can display the image. Some embodiments can include displaying an application interface on each of the plurality of client applications substantially simultaneously with the image.

This application claims priority under 35 U.S.C. §119 to U.S. Provisional Patent Application No. 61/317,556 filed on Mar. 25, 2010, the entirety of which is incorporated herein by reference.

### BACKGROUND

Collaboration among medical professionals can be important for improving patients' medical experience. The sharing of information between medical professionals can, at least partially, lead to more accurate assessments of clinical data. For some medical collaborations, some medical professionals may review physical copies of patient data (i.e., radiographic images, histological specimen images, ultrasound images, etc.) and may then annotate and pass that review along to the next medical profession for their review, which can be difficult when the professionals are not in the same general physical location.

### SUMMARY

Some embodiments of the invention provide a method of medical collaboration. Some embodiments include a server application receiving and storing an image via an uploading application. In some embodiments, the image can be stored in a database, and upon receiving a request to view the image from a plurality of client applications, the image can be transmitted to the plurality of client applications so that each of the client applications can display the image. Some embodiments can include displaying an application interface on each of the plurality of client applications substantially simultaneously with the image.

Some embodiments of the invention provide another method of medical collaboration. Some embodiments include receiving a request to display an image stored on a system database from a plurality of client applications and transmitting the image to each of the plurality of client applications. Some embodiments include substantially simultaneously displaying the image on a client application drawing interface on each of the plurality of client applications. Some embodiments can provide receiving and processing at least one annotation instruction from at least one of the plurality of client applications, and substantially simultaneously displaying an annotation element corresponding to the annotation instruction on each of the client application drawing interfaces of each of the plurality of client applications.

Some embodiments of the invention include a medical collaboration system comprising an uploading application, a server application, and at least a first client application. In some embodiments, the uploading application can be capable of transmitting an image over a network and the server application can be capable of receiving the image from the uploading application and storing it in a database. In some embodiments, the first client application can be capable of transmitting a request to view the image to the server application or a second client application. The first client application also can be capable of receiving the image and displaying the image and an application interface substantially simultaneously.

### DESCRIPTION OF THE DRAWINGS

FIG. 1 illustrates a network architecture for an online radiology and collaboration system according to one embodiment of the invention.

FIGS. 2A and 2B illustrate communication paths between applications of the online radiology and collaboration system.

FIGS. 3A and 3B are screenshots of a client application user interface of the online radiology and collaboration system.

FIGS. 4A and 4B are screenshots of a dashboard interface and a drawing interface, respectively, of the client application user interface.

FIGS. 5A-5I are screenshots showing different annotation elements used with the drawing interface.

FIG. 6 are simultaneous screenshots of images from two different workstations.

FIG. 7 is a screenshot of a broadcasting interface of the user client application user interface.

FIG. 8 is a screenshot of a uploading application of the online collaboration system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention provide a medical collaboration system 10. The medical collaboration system 10 can comprise a substantially web-based imaging PACs (Picture Archiving and Communication Systems) system, which can allow medical professionals and end users to share and collaborate image data, substantially in real time. The system 10 can include a series of two-dimensional drawing tools 12 that can be used to annotate medical images 14 from a database 16. A user can retrieve an original image 14 or a series of original images 14 from the database 16 via a secure connection 18 (e.g., using a Secure Socket Layer, or SSL). In some embodiments, the original image 14 stored in the database 16 can be stored as a lossless image and is not modifiable. Once the original image 14 is retrieved, a copy of it can be loaded as a new, modifiable image 14 into a web browser for use with the system 10. Suitable web browsers in some embodiments can include Windows Internet Explorer, Mozilla Firefox, Safari, or similar browsers. In some embodiments, the user can annotate the modifiable image using the drawing tools 12, creating a series of annotation elements 20. In some embodiments, the system 10 can be configured so that resizing and/or minimizing and maximizing the web browser does not affect the images 14, drawing tools 12, or annotation elements 20. In some embodiments, the system 10 can enable other forms of collaboration, such as, but not limited to, veterinary collaboration, engineering collaboration, educational collaboration, architectural collaboration, business collaboration, and other collaborations.

In some embodiments, the system 10 can consist of three types of applications: server applications 22, client applications 24, and uploading applications 26. In some embodiments, a server application 22 can act as a global database and processing application. The server application 22 can track all activity that users are performing with the system 10. For example, when a user logs in, the server application 22 can process the user log-in and redirect the user to a client application 24, allowing the user to view a user interface 28 including a dashboard interface 30 and a drawing interface 32.

In some embodiments, the server application 22 can also include an administration portion, which can allow one or more system administrator accounts to manage users and/or groups. For example, a system administrator account can assign a single user, a set of individual users, or a group to a study. The administration portion of the server application 22 can also track statuses and network information of client applications 24, uploading applications 26, and some other server applications 22. For example, if an uploading application 26 is active, it can register itself with the server application 24 and the administration portion can track the data that has been uploaded. In another example, the administration portion can manage the status of all client applications 24 to check the status of the network connectivity running in multiple locations.

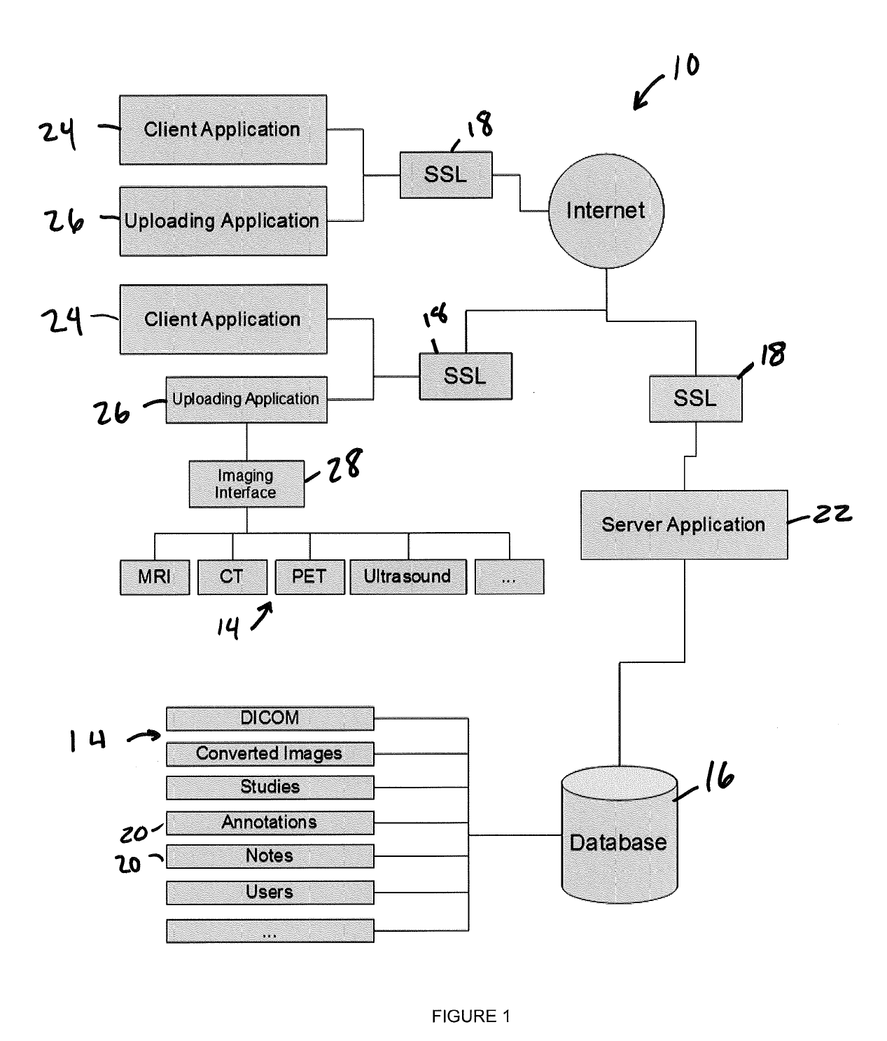

FIG. 1 illustrates a network architecture of the system 10. The server applications 22 can comprise standard web-based servers which can use Hypertext Transfer Protocol (HTTP) requests for some methods of communication and “handshaking” across a network (e.g., the Internet). In some embodiments, responses from the HTTP requests can be sent using Extensible Markup Language (XML). In some embodiments, multi-party communication can be achieved between a client application 24 and a server application 22 through “heartbeat” requests at specified intervals. For example, if an image 14 has been updated at a client application 24, that client application 24 can send a heartbeat to the server application 22 notifying the server that an image 14 has been updated, annotated, or otherwise altered. The request can be saved into the database 16. Other client applications 24 viewing the same image 14 can also receive a notification as a heartbeat response notifying that the image 14 has been annotated.

In some embodiments, when the uploading application 26 uploads an image 14 or a video 34 (e.g., in a Digital Imaging and Communications in Medicine, or DICOM format) to a server application 22, the server application 22 can store and convert the data into thumbnails and lossless image files. The thumbnails and lossless image files can be used for displaying previews and can be transferred from the server application 22 to the client application 24 so that the client application 24 does not require built-in DICOM functionality. In addition, the original DICOM file that was uploaded to the server application 22 can be archived in the database 16 and linked to a specific study so that it can be accessed at a later date for future iterations and versions. Moreover, in some embodiments, the uploading application 26 can enable substantially any user with access to the system 10 to upload an image file (i.e., a DICOM file, an echocardiogram, an encephalogram, a histological section image, and other similar images) from generally any location comprising a network connection so that any other user can view, annotate, and/or otherwise access the file. For example, in some embodiments, a mobile medical imaging unit, via the uploading application 26, can upload an image file 14 and/or a video 34 file from substantially any location comprising a network connection so that a user can access that uploaded file from another location comprising a network connection.

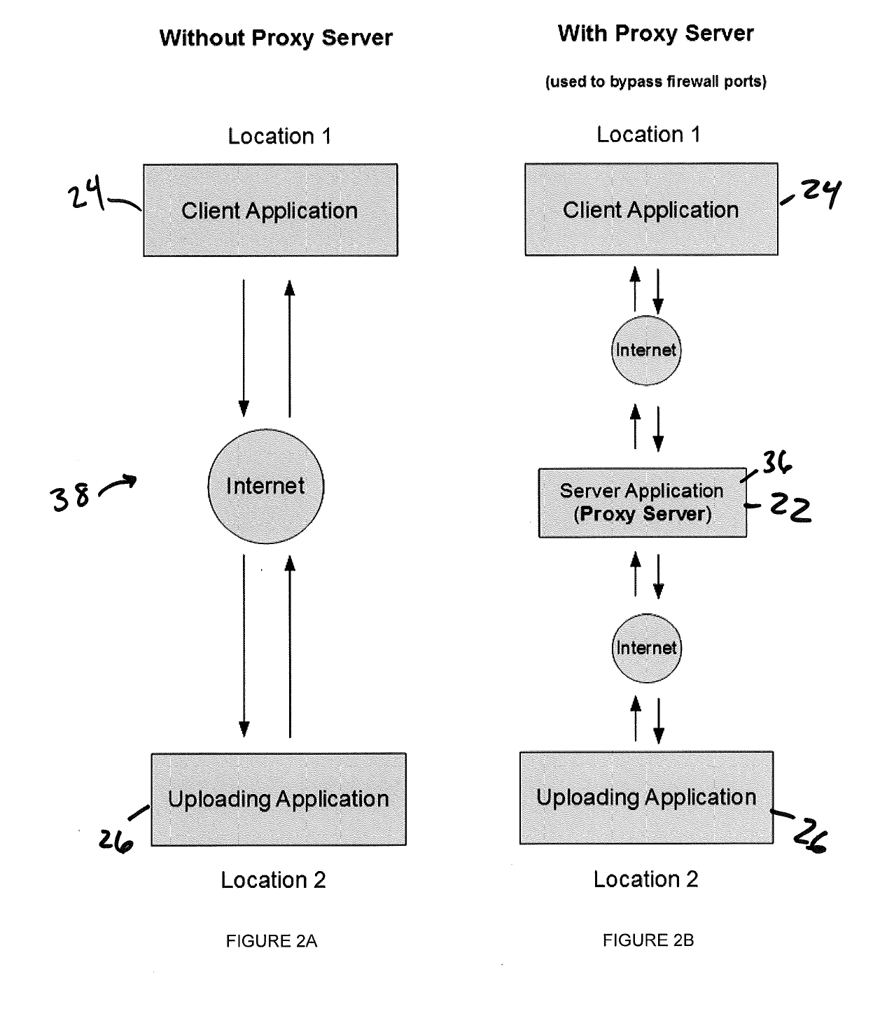

In some embodiments, the server application 22, as shown in FIG. 2B, can function as a proxy server 36 when transferring images 14 directly from an uploading application 26 to a client application 24. Alternatively, as shown in FIG. 2A, the system 10 can allow peer-to-peer access 38 directly from the uploading application 26 to the client application 24 without waiting for the uploading application 26 to transfer all of the data first to the server application 22.

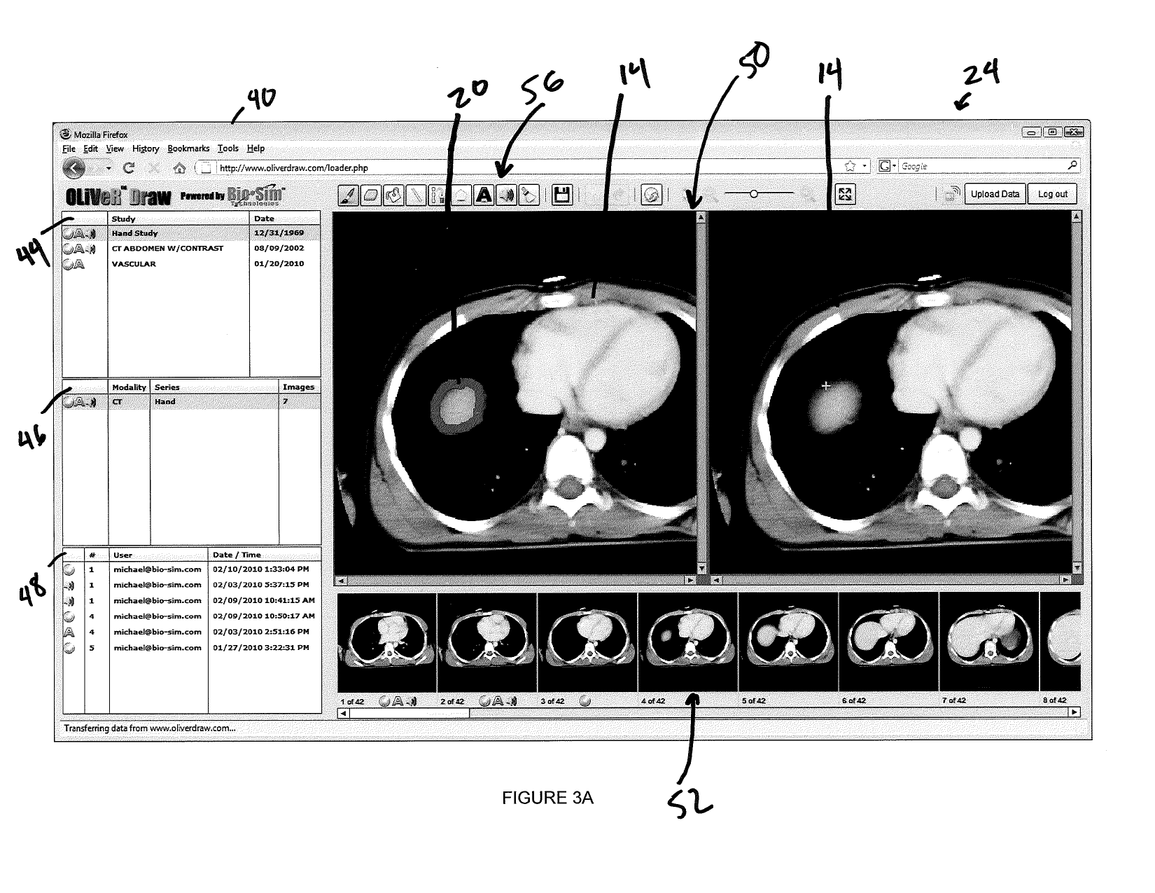

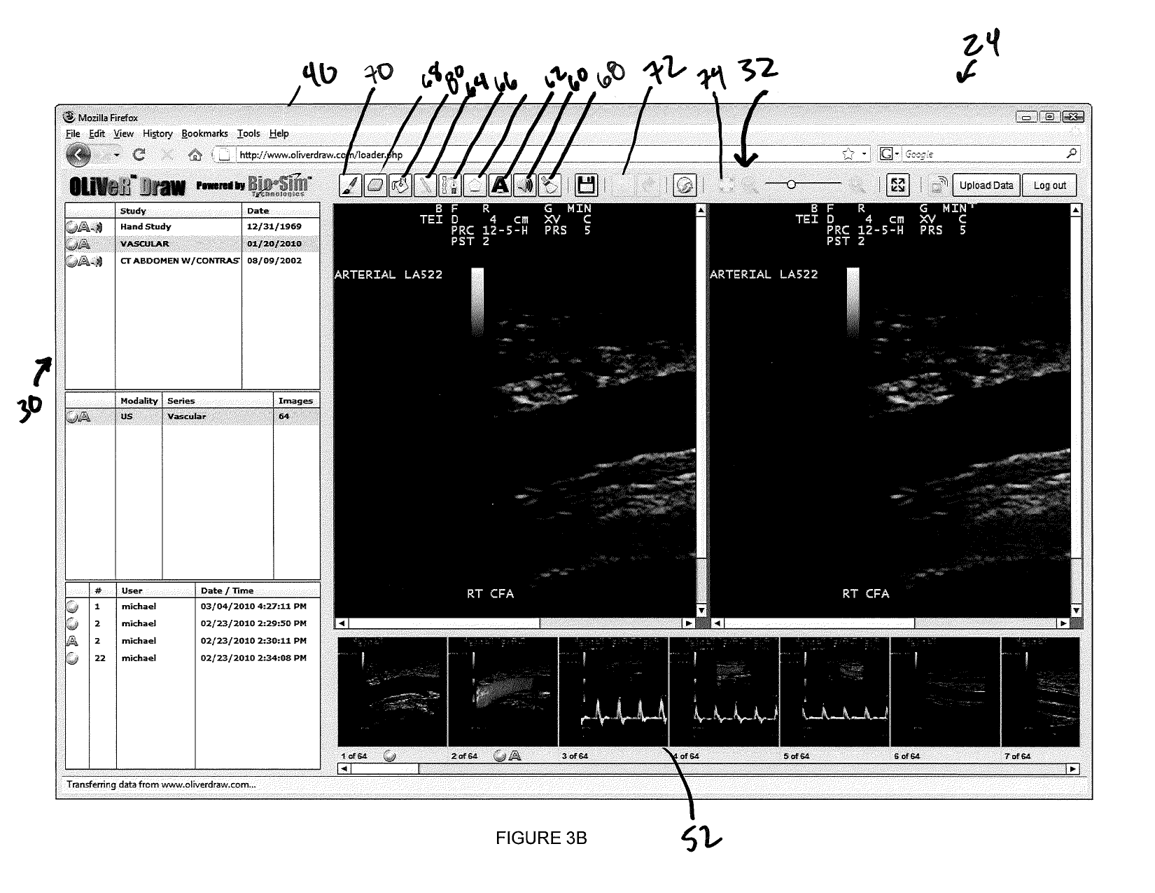

In some embodiments, the client application 24 can be a front-end portion of the system 10. The client application 24, as shown in FIGS. 3A and 3B, can have an application interface 40 including the dashboard interface 30, the drawing interface 32, and a broadcast interface 42. In some embodiments, when a user logs into the system 10, the dashboard interface 30 can be displayed showing the status of any studies that are assigned to the user's account. The drawing interface 32 can allow the user to view images 14 associated with their assigned studies along with a series of annotation and drawing functions.

In some embodiments, the network infrastructure of the client applications 24 can use standard HTTP requests for all communications, as previously mentioned. The network architecture of the uploading application 26 can allow relatively direct data uploading from the uploading application 26 in a peer-to-peer form 38 or by using a proxy connection 36 through the server application 22, as shown in FIGS. 2A and 2B. In some embodiments, the peer-to-peer ability can allow data to be shared substantially immediately after it has been acquired by the uploading application 26. When an image 14 is requested during uploading data to the server application 22, the client application 24 can directly connect to the uploading application 26 with an HTTP request to obtain the image or images 14 selected. The uploading application 26 can continue to transfer the acquired images 14 to the server application 22 as a background task. As a result, in some embodiments, the client application 24 can access some images 14 immediately from the uploading application 26 or at a future time from the server application 22. In some embodiments, a proxy connection 36 can be used through the server application 22 if a workstation or medical device using the uploading application 26 is behind a network firewall. In some embodiments, at least a portion of the data from the uploading application 26 can be transferred as HTTP requests over an SSL connection to the server applications 22 and client applications 24.

In some embodiments, the client application 24 comprises heartbeat function. The heartbeat function can allow the client application 24 to receive data and notifications. In some embodiments, by using a specified interval, the heartbeat process can send a request to the server application 22 including a set of specified parameters. The server application 22 can track the state of the client application 24 and can send back commands to the client application 24. By way of example only, in some embodiments, a “user A” is in the process of uploading image data (which is assigned to a “user B”) to the server. A heartbeat request from user B is sent to the server application 22, the server application 22 processes the heartbeat and sends a response notifying user B that new image data has been uploaded without refreshing the user B's web browser.

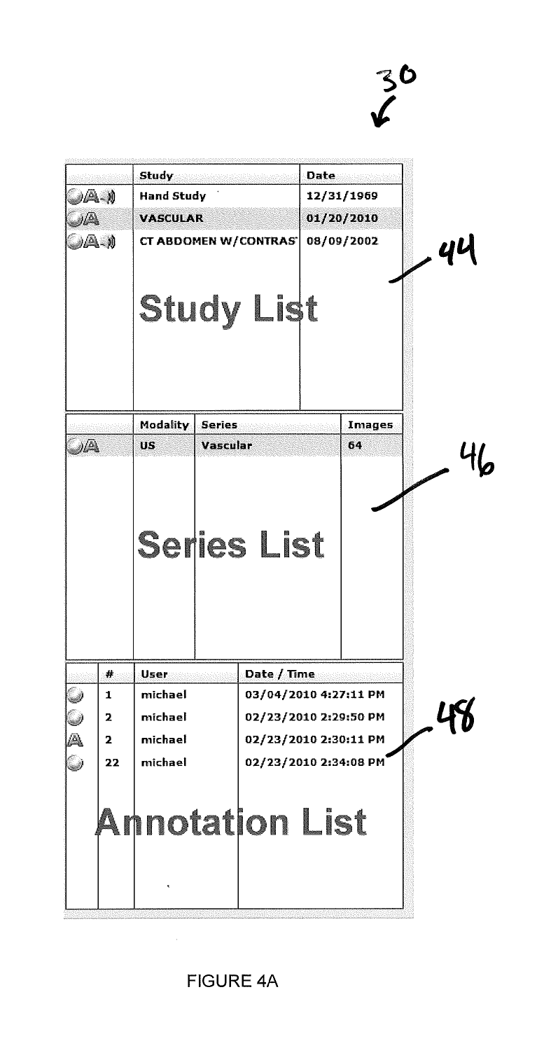

FIG. 4A illustrates the client application dashboard interface 30. When a user logs into a client application 24, a list of studies that are assigned to that user can be displayed on a side of the application interface 40 (as shown in FIGS. 3A and 3B). In some embodiments, as shown in FIG. 4A, the dashboard interface 30 can include a study list 44, a list of series 46, and an annotation list 48, although in other embodiments, the dashboard interface 30 can comprise other elements. The study list 44 can be used to navigate between different studies. Each study can comprise a different elements, including but not limited to a specific type, description, date, patient, and location, as well as specific users assigned to it. In some embodiments, studies can be assigned to individual users or a group of users.

Moreover, in some embodiments, nested under the studies 44 can be the list of series 46. A series 46 can include a set of images 14 with an assigned name and/or date. Also, the annotation list 48 can be nested under the series list 46. In some embodiments, when a user adds annotations to one or more images 14, the annotation list 48 can be automatically updated showing the type of annotation (drawing, note, etc.). The date, user, image number and type of annotation are tracked and can be accessed by selecting the annotation in the annotation list 48. This can allow a relatively simple way to access and view annotation changes made by other users. In some embodiments, clicking on an annotation in the list can lead to displaying the image 14 with the saved annotations. In some embodiments, if the user substantially clears, alters, or deletes an annotation on the image 14, the entry in the annotation list 48 can still be listed, but can become highlighted (e.g., in red) or otherwise demarcated. This can allow the user to track annotations over time. When the user selects different study, the previous image and state can be preserved for future study viewings.

FIG. 4B illustrates the client application drawing interface 32. In some embodiments, the drawing interface 32 can include a primary image viewer 50, a secondary image viewer 52, a selection tool 54, and a tool control bar 56. In some embodiments, the drawing interface 32 can employ programming API's and can allow a user to annotate an existing, modifiable image 14 (e.g., in an annotation window) alongside an untouched image (e.g., in an untouched window). The untouched images 14 and annotated images 14 can be stored in a database on the server application 22 as lossless compressed portable network graphics (“.PNG”) files. In some embodiments, the secondary image viewer 52 can display a series of thumbnails. The selection tool 54 can allow the user to select (e.g., with a computer mouse or touchpad) a thumbnail from the secondary image viewer 52. Once the thumbnail is selected, its corresponding image can be displayed on the primary image viewer 50 for annotating. The primary image viewer 50 can display the modifiable image 14 for annotating as well as its untouched original image 14 for comparison.

In some embodiments of the invention, only the modifiable image in the primary image viewer 50 can be annotated. In some embodiments, however, the user can select another thumbnail from the secondary image viewer 52 to display it on the primary image viewer 50 for annotating or toggle between multiple images 14 without losing any annotation elements 20 created on the images 14. In some embodiments, thumbnails in the secondary image viewer 52 that contain annotation elements 20 can each include a small icon so that the user knows which images 14 have been annotated. In some embodiments, the user can also select images 14 to view on the primary image viewer 50 by using arrows on the tool control bar 56. For example, clicking the left arrow can allow the thumbnail to the left of the currently selected thumbnail in the secondary image viewer 52 to be selected and its corresponding image 14 displayed in the primary image viewer 50.

In some embodiments, the client application 24 can comprise at least the following drawing and annotation functionalities: a note tool 58, an audio note tool 60, a text tool 62, a line tool 64, a curve tool 66, an eraser tool 68, a brush tool 70, an undo tool 72, a zoom tool 74, measurement tools 76, a rotation tool 78, and a mapping tool 80. In some embodiments, the tool control bar 56 can include icons associated with at least some of the above-mentioned tools. In some embodiments, once a user selects a tool, the user can create an annotation element 20 (e.g., note, line, curve, etc.) on the modifiable image 14 with the tool. Further, in some embodiments, once the user creates the annotation element 20, the user can again select the selection tool 54 on the tool control bar 56. Using the selection tool 54, the user can select the annotation element 20 (or other tools on the tool control bar 56). In some embodiments, if the user selects an annotation element 20, the tool control bar 56 can change to include edit options specific to the selected annotation element 20 so that the user can edit the annotation element 20. Tool functionalities are further described in the following paragraphs.

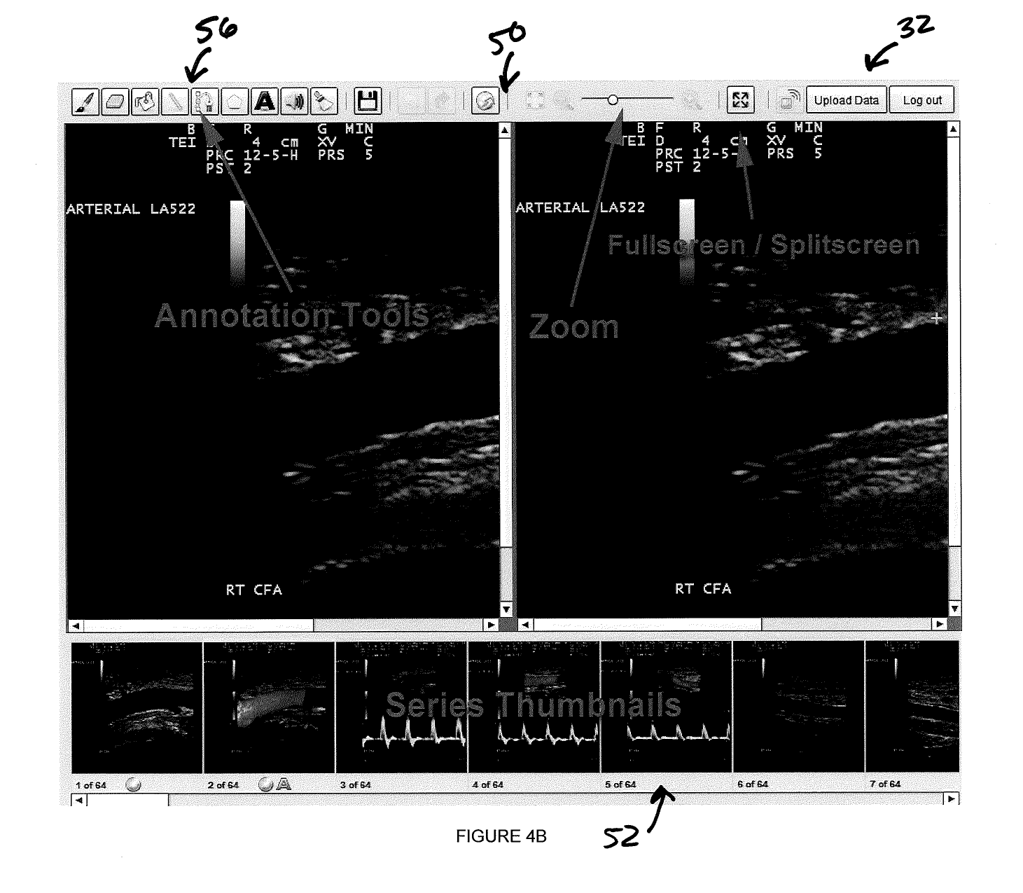

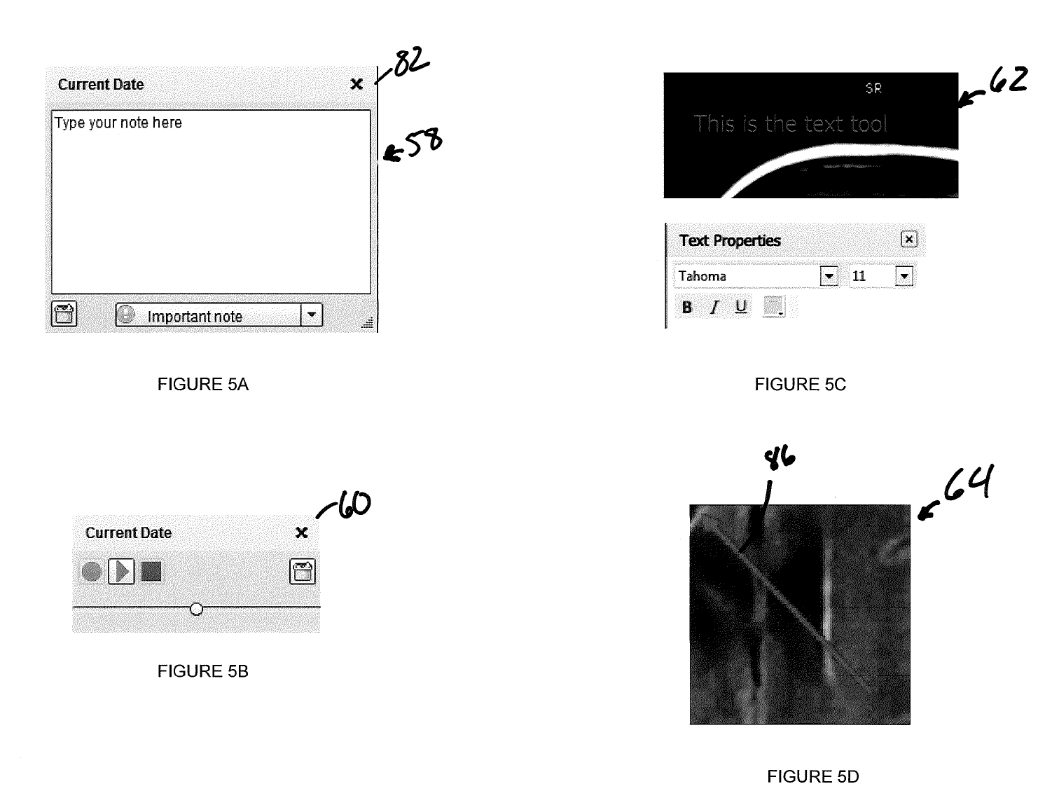

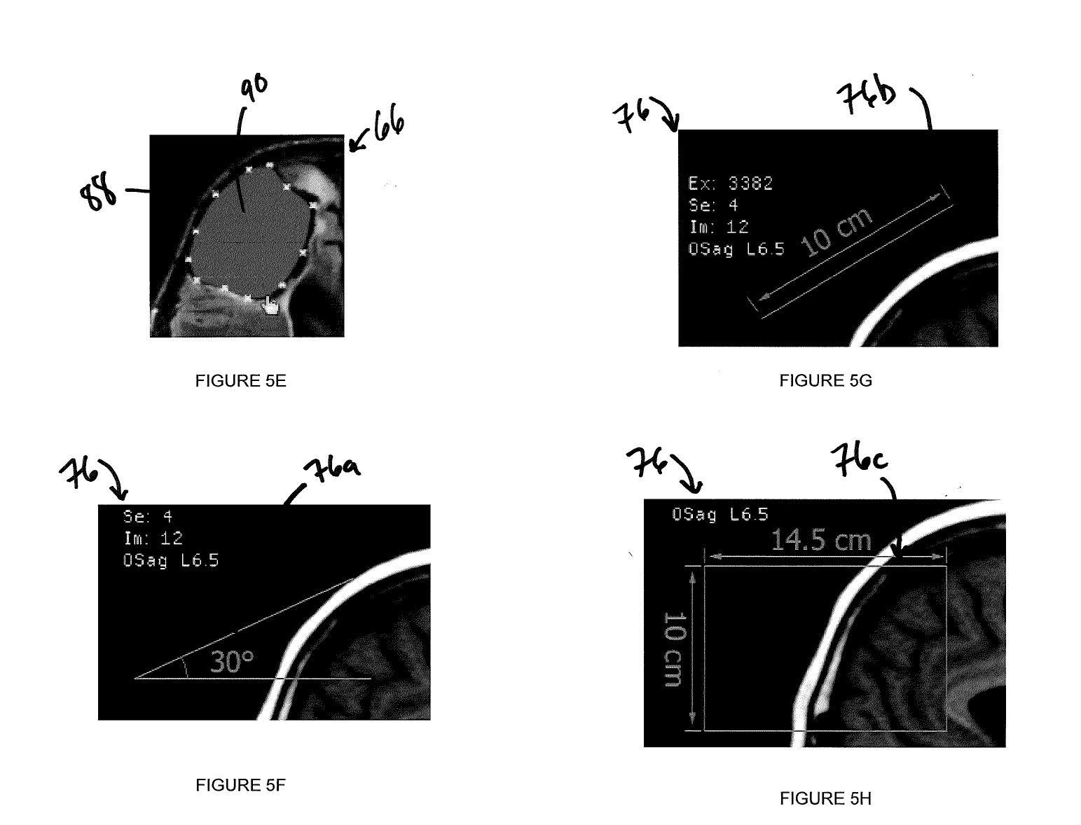

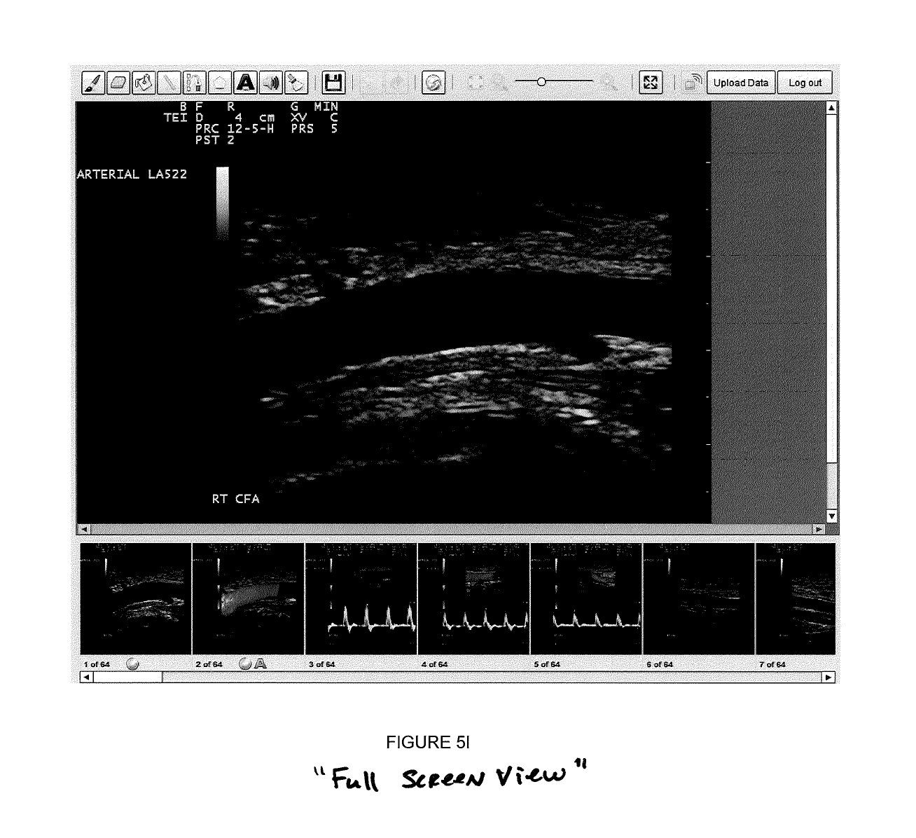

In some embodiments, the note tool 58 can enable pop-up notes to be added to an image 14. For example, FIG. 5A illustrates a pop-up note 82. In some embodiments, once a user creates a pop-up note 82, the user can edit text in the note, delete, save, move, or resize the note, or change the color of the note. In some embodiments, pop up notes 82 can be listed in the annotation list 48 as type “Note” or a similar heading. In some embodiments, a user can retrieve the note 82 and its associated image 14 by selecting on the note in the annotation list 48.

In some embodiments, the audio notes tool 60 can enable audio notes to be added to some of the images 14. In some embodiments, when a user adds an audio note, the user can record an audio segment and save the segment with the associated image 14. In some embodiments, the audio note can have functionality such as text, microphone gain, record, play, and stop. In some embodiments, a recorded audio note can be indicated as a pop up note 84 on the image 14 (which can be resizable, moveable, etc.), such as that shown in FIG. 5B, and can be listed in the annotation list 48 as type “Note” or a similar heading. In addition, in some embodiments, the audio notes tool 60 can include video recording functionality to record video 34 and/or audio notes.

In some embodiments, the text tool 62 can enable the ability to add text on a layer of the image 14. The text tool 62 can be different than the note tool 58 because the note tool 58 can place an icon over the image which has its own properties (such as audio or video). The text tool 62 can be used to add text as a new graphical layer onto the image 14 and can be labeled as type “Text” in the annotation list 48. FIG. 5C illustrates text created on an image using the text tool 62. Further, in some embodiments, when text is added with the text tool, a user can specify the font, size, color, and type, etc. as shown in FIG. 5C.

In some embodiments, the line tool 64 can enable a user to draw a line 86 on the image 14. Once the user has selected the line tool 64, they can click and drag the tool across the image to create the line 86. For example, the user can click their mouse button to define the line's 86 starting point, and then drag the mouse to create the line 86. FIG. 5D illustrates a line 86 created on an image using the line tool 64. In some embodiments, once the user creates a line 86, it can be automatically selected, allowing the user to immediately edit the line 86 without reselecting it using the selection tool 54. In some embodiments, when the user selects the line tool 64, the user can edit properties such as line thickness, add/remove arrows, color, and position points. In addition, in some embodiments, the user can choose between five different line styles: solid, dotted, dashed, arrow start, and arrow end. A user can also create shapes with multiple lines 86. In some embodiments, once a closed shape is created, the user can have the option to fill the shape with a color. All color changes can be accomplished using a color tool.

In some embodiments, the curve tool 66 can enable a user to draw a curve 88 with multiple points. In some embodiments, once the user selects the curve tool 66, they can click (e.g., with the left mouse button) once, drag the tool across the image, and click again to add another point along a curve 88. In some embodiments, the user can continue clicking to add multiple points to the curve 88 and then double-click to end the curve 88. In some embodiments, after the user creates at least a portion of the curve 88, it can be substantially automatically selected so that the user can edit and refine the curve 88 by using “curve widgets” (not shown). In some embodiments, the user can edit properties such as modifying line thickness, changing the color, and editing points to move some or all of the curve 88. The user also has the option to close the curve 88 to create a region 90. In some embodiments, when a curve 88 is closed, the user can also use the color tool to fill the region 90 formed with the current curve 88 color. For example, FIG. 5E illustrates a closed and filled-in region 90 created on an image 14 using the curve tool 66.

In some embodiments, the eraser tool 68 can be used to remove any colored areas created on an image 14. In some embodiments, when the user selects the eraser tool 68, they can change the size of the eraser tool 68 under the tool control bar 56. Also, in some embodiments, the eraser tool 68 can erase more than one element at a time (i.e., all layers over the original image in the selected spot), or only remove elements on a selected layer.

In some embodiments, the brush tool 70 can enable the user to create, or “paint,” a brush stroke on the image 14. In some embodiments, once the user selects the brush tool 70, they can click once and drag the tool across the image to create a brush stroke. In some embodiments, each brush stroke created can be a separate, editable annotation element 20. Further, in some embodiments, after a brush stroke, the user can edit the color or merge the brush stroke with another brush stroke to create a single region. In some embodiments, edit options for brush strokes can include modifying color, thickness, shape, hardness, and opacity of the brush stroke. Moreover, in some embodiments, each time the brush tool is used, a separate layer can be created for that brush stroke.

In some embodiments, the undo tool 72 can enable the user to reverse annotation actions. Annotation actions can include any annotation elements 20 created and any changes made to the annotation elements 20. For example, in some embodiments, if the user created a line 86 on the image, they can use the undo tool 72 to remove the line 86. In some embodiments of the invention, undo events can be separated between images 14. As a result, using the undo tool 72 can only affect the image 14 that is currently being annotated (i.e., the image displayed in the primary image viewer 50). As a result, switching to a different image 14 and using the undo tool 72 can then reverse the last annotation action on that image 14. Further, in some embodiments, not all of the elements and changes need be cued so that they can be reversed.

In some embodiments, the zoom tool 74 can enable the user to zoom in or out on the image 14. In some embodiments, the user can use a joint image zoom option, which can link and zoom both images 14 (i.e., the modifiable image and the untouched image) in the primary image viewer 50 in or out substantially simultaneously. In some embodiments, the user can also use a demarcated area zoom option, where the user can select an area on the modifiable image and the zoom tool will zoom in and center on that selected area.

In some embodiments, the measurement tools 76 can enable different measurements to be illustrated on images 14, such as distances or angles. In some embodiments, each measurement tool 76 can be flattened and treated as a colored layer after it is drawn and a new, separate layer can be created for each new measurement on an image. In some embodiments, tools such as the eraser tool 68 can erase areas of measurement. Also, colors can be edited for each measurement annotation on an image.

In some embodiments, a measurement angle tool 76a can enable an angle to be measured on the image 14. For example, in some embodiments, the user can draw a first line, and after the first line is drawn a second line can be automatically added using a first point on the first line as a pivot and the user can move their mouse to the left and right to adjust the angle. FIG. 5F illustrates a measured angle on an image using the measurement angle tool 76a. In some embodiments, a measurement line tool 76b can measure a distance between two selected points. FIG. 5G illustrates a measured distance on an image using the measurement line tool 76b. In some embodiments, a measurement rectangle tool 76c can measure a height and a width of a rectangular area. The user can select two points to draw the rectangular area. FIG. 5H illustrates a measured rectangle on an image using the measurement rectangle tool 76c.

In some embodiments, the rotation tool 78 can enable a user to move the modifiable image 14 horizontally or vertically in real time, depending on parameters specified. In some embodiments, the user can also use the rotation tool 78 to rotate the modifiable image 14 by a preset value or a specified value. Moreover, in some embodiments, when an image is rotated, current annotation elements 20 on the image can also be rotated, and any text in annotation elements 20 can stay in its original orientation when the annotation elements are rotated with the image 14.

In some embodiments, the user can also select to expand an image for a full-screen view, as shown in FIG. 5I. For example, the user can choose to expand the annotation window or the untouched window for full-screen viewing. In some embodiments, the client application 24 can also include a mapping tool 80 that can enable the position of the selection tool 54 on the modifiable image 14 to be mapped or mirrored on the untouched image in the primary image viewer 50 for comparison.

In some embodiments, the client application 24 can also include a circle tool (now shown), which can allow the user to create circles on the image 14. For example, once the user has selected the circle tool, they can click and drag the tool across the image to create a circle. In some embodiments, once created, the user can edit properties such as modify line thickness, change the color, add a fill color (i.e., fill the circle with a color), and edit end points to move some or all of the circle. In addition, in some embodiments, the user can create a predefined circle with specific characteristics. For example, once the circle tool is selected, a pop up box can be displayed where the user can enter desired characteristics, such as diameter, center point, and/or radius.

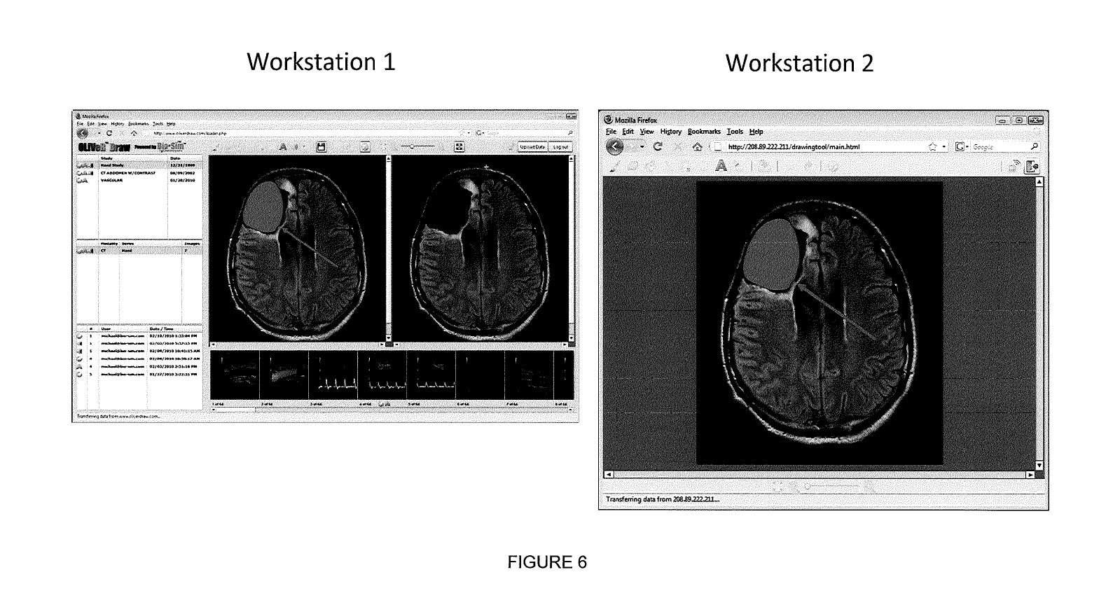

In some embodiments, when a user adds annotation elements 20 or images 14 are added, notifications can be sent out to a single or group of users that are assigned to the study associated with the images 14. In some embodiments, notification delivery types can include e-mail and Short Message Service (SMS) for mobile devices. For example, as shown in FIG. 6, a user at workstation 1 has annotated an image 14 in a study assigned to a user at workstation 2. The user at workstation 2 can receive a notification that the image was annotated and choose to the view that annotation image at their workstation.

In some embodiments, the client application 24 can transfer some of the annotation elements 20 and the modified images 14 to the database securely with an authenticated connection. In some embodiments, the modified images 14 and the annotation elements 20 can then be saved into the database 16. In some embodiments, a table in the database can separately store each annotation element 20. The server application 22 can retrieve the modified images 14 and annotation elements 20 for further annotating.

In some embodiments, user profiles can be set for individual users that want to save there tool defaults. When changes are made with any of tool settings, the client application 22 can automatically save those settings to the user's profile. For example, in some embodiments these settings can be saved on the server application 22 (e.g., in the database 16), so that the settings are not lost and the next time a user logs in and views a study, the tools parameters can then be identical to the user's previous session.

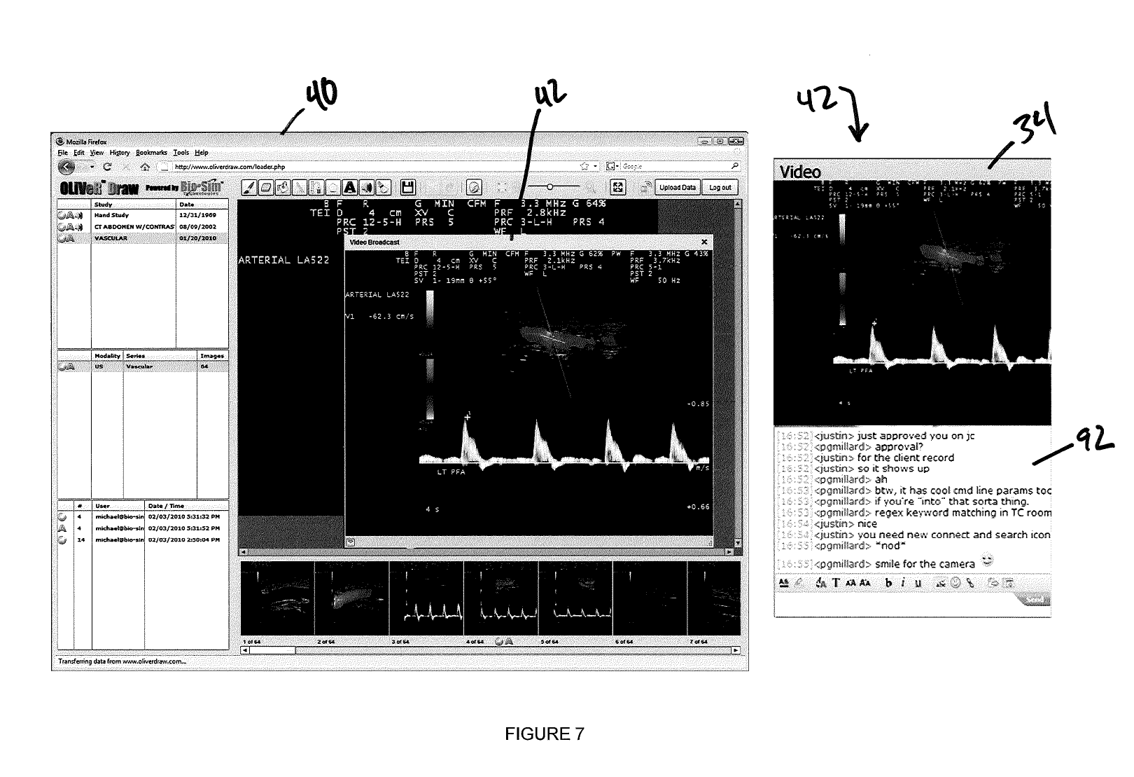

In some embodiments of the invention, the client application 24 can include live broadcasting functionality through a broadcast interface 42, as shown in FIG. 7. In some embodiments, live collaborative functions can allow the use of broadcasting video and audio. In some embodiments, the broadcasting functionality can also enable text chat 92 between users viewing the broadcast and/or those broadcasting the video 34, as shown in FIG. 7. Also, in some embodiments, multiple capture devices can be used to broadcast. For example, a live feed of an ultrasound machine can be broadcasting in sync with a web cam showing the position of the ultrasound probe device on the body. In some embodiments, the live broadcasts can also be saved and archived as a video file, which can be linked to a specific study or individual image 14. In some embodiments, during live broadcasting, snapshots of the video streams 34 can also be captured and saved in the appropriate study.

In some embodiments, automatic notification of any broadcasting during studies can also be accomplished through the client application 24. In some embodiments, a small icon can be displayed next to the study (e.g., on the study list 44) when a video broadcast is started. By selecting the study, the user can be prompted to view the broadcast 34. In some embodiments, if the user chooses to view the broadcast, the broadcast interface 42 can automatically open. In some embodiments, when a broadcast is terminated, the broadcast interface 42 can automatically close for users that were viewing the broadcast session.

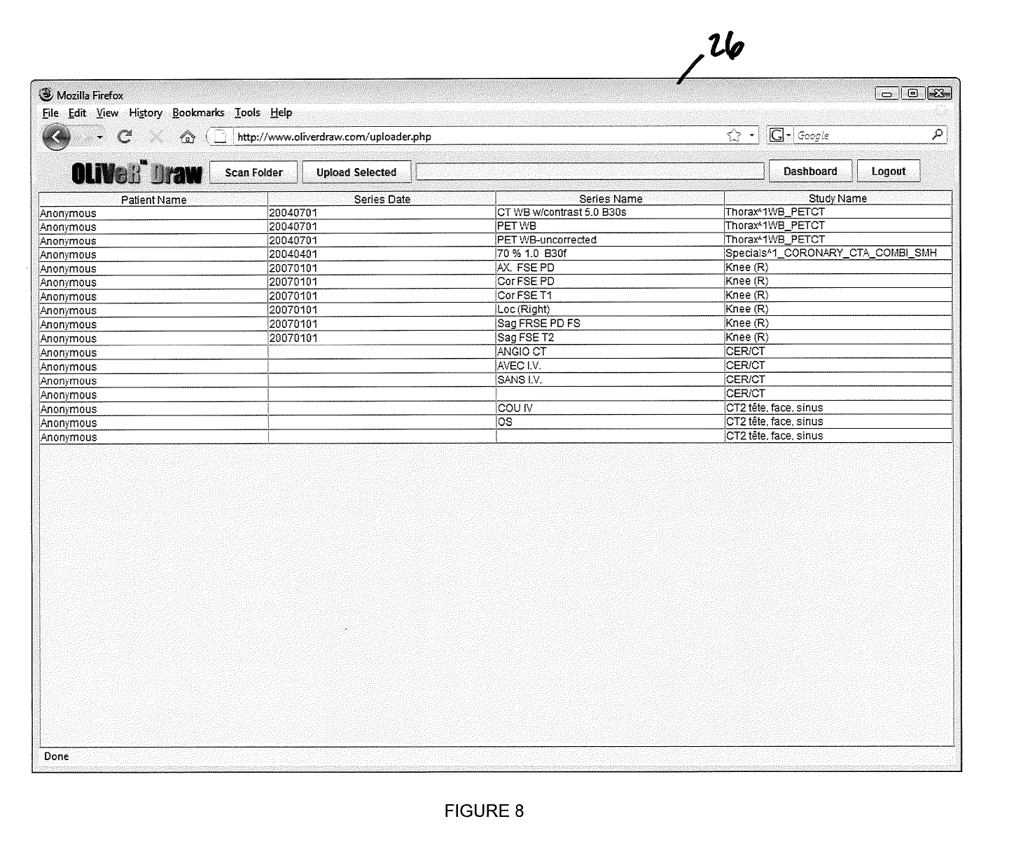

FIG. 8 illustrates an uploading application 26 according to one embodiment of the invention. In some embodiments, data can be uploaded directly into the online medical and collaboration system 10. In some embodiments, when data is uploaded, it can be assigned to a single user or group of users. The uploading application 26 can support a range of data types, such as DICOM data, or image 14 or video 34 files. The uploading application 26 can scan a specified directory, mobile device, or diagnostic medical device and automatically acquire the image data.

For example, in some embodiments, a series of image files can be selected or scanned from a directory on a computer, mobile device or a diagnostic medical device. In some embodiments, DICOM images 14 can be processed and converted to a modern and standard PNG or lossless JPG format for standard distribution using a web browser, flash and/or java platforms. Original DICOM files can be stored on the database 16 of the server application 22 for archiving. Video 34 can also be uploaded and saved. Frames from the video files can also be extracted into individual images 14 and saved.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

1. A method of medical collaboration, the method comprising:
receiving an image, the image received by a server application and transmitted using an uploading application;
storing the image in a database;
receiving a request to view the image from a plurality of client applications;
transmitting the image to the plurality of client applications so that each of the plurality of client applications display the image; and
displaying an application interface on each of the plurality of client applications substantially simultaneously with the image.

2. The method of claim 1, wherein the client application further comprises a dashboard interface.

3. The method of claim 1, wherein the application interface comprises a drawing interface, the drawing interface includes a primary image viewer and a secondary image viewer.

4. The method of claim 1, wherein the application interface comprises a tool control bar, wherein the tool bar includes at least two of a note tool, an audio tool, a text tool, a line tool, a curve tool, an eraser tool, a brush tool, an undo tool, a zoom tool, a plurality of measurement tools, a rotation tool, and a mapping tool.

5. The method of claim 1 and further comprising receiving annotation instructions from at least one of the plurality of client applications.

6. The method of claim 5 and further comprising displaying at least one annotation element corresponding to the annotation instructions on at least one of the client applications.

7. The method of claim 6 and further comprising displaying the at least one annotation element on each of the plurality of client applications viewing the image, and wherein the at least one annotation element is displayed on each of the plurality of client applications substantially in real-time.

8. The method of claim 7 and further comprising storing the at least one annotation element on the database and displaying a record of the at least one annotation in an annotation list.

9. The method of claim 1, wherein the image comprises one of a DICOM image, an echocardiogram, an MRI image, an ultrasound, and a histological section image.

10. The method of claim 1, wherein the image originates from at least one of medical device, a mobile device, a CD-ROM, a PAC system, a DVD, other removable media, and a directory on a computer.

11. A method of medical collaboration, the method comprising:
receiving a request to display an image stored on a system database from a plurality of client applications;
substantially simultaneously transmitting the image to the plurality of client applications;
substantially simultaneously displaying the image on a client application drawing interface of each of the plurality of client applications;
receiving and processing at least one annotation instruction from at least one of the plurality of client applications; and
substantially simultaneously displaying an annotation element corresponding to the at least one annotation instruction on each of the client application drawing interfaces of each of the plurality of client applications.

12. The method of claim 11, wherein the client application drawing interface comprises a primary image viewer, a secondary image viewer, a selection tool, and a tool control bar.

13. The method of claim 12, wherein the tool control bar comprises at least two of a note tool, an audio tool, a text tool, a line tool, a curve tool, an eraser tool, a brush tool, an undo tool, a zoom tool, a plurality of measurement tools, a rotation tool, and a mapping tool.

14. The method of claim 11, wherein the image further comprises a video.

15. The method of claim 11, wherein the client application further comprises a broadcast interface.

16. The method of claim 15, wherein the broadcast interface is capable of enabling at least one of a real-time time text chat, a real-time voice chat, and a real-time video between a plurality of users.

17. The method of claim 11, wherein the client application further comprises a dashboard interface.

18. A medical collaboration system comprising:
an uploading application capable of transmitting an image over a network;
a server application capable of receiving the image from the uploading application, the server application capable of storing the image on a database; and
a first client application,
the first client application capable of transmitting a request to view the image to one of the server application and a second client application,
the first client application capable of receiving the image, and
the first client application capable of displaying the image and an application interface substantially simultaneously.

19. The system of claim 18, wherein the application interface comprises a dashboard interface, a drawing interface, and a broadcast interface.

20. The system of claim 18, wherein the first client application is configured to display annotation elements in response receiving annotation instructions.
